(19) United States
(12) Patent Application Publication
(10) Pub. No.: US 2013/0094386 A1
(43) Pub. Date: Apr. 18, 2013

(54) COMMUNICATION TERMINAL DEVICE AND COMMUNICATION METHOD

(71) Applicant: Akira Kawamura, Kanagawa (JP)

(72) Inventor: Akira Kawamura, Kanagawa (JP)

(73) Assignee: PANASONIC CORPORATION, OSAKA (JP)

(21) Appl. No.: 13/703,839

(22) PCT Filed: Jun. 17, 2011
(86) PCT No.: PCT/JP2011/003473

§ 371 Date: Dec. 12, 2012

(30) Foreign Application Priority Data
Jun. 18, 2010 (JP) 2010-139866

(51) Int. Cl. H04W 76/04

(52) U.S. Cl. CPC H04W 76/04
USPC 370/252

(57) ABSTRACT

A communication terminal device which can negate the need for troublesome switchovers and increase ease of use. In the device, a communication unit is connected to a client and carries out short distance wireless communication. An AP operation unit relays the transfer of data between the client and the connection destination thereof, on behalf of an access point. An electric field intensity acquisition unit measures the electric field intensity of a signal received from the access point. A client connection cancellation unit determines whether the device is within the communication area of the access point on the basis of the electric field intensity measured by the electric field intensity acquisition unit. If it is determined by the client connection cancellation unit that the device is within the communication area of the access point, an AP operation termination unit cancels the connection with the client in the AP operation unit.

### TECHNICAL FIELD

The present invention relates to a communication terminal apparatus that operates in particular as an access point and to a communicating method.

### BACKGROUND ART

Conventionally, a mobile terminal apparatus that has an access point mode and operates as an access point is known. Such a mobile terminal apparatus connects to a client such as a portable gaming device via a wireless LAN, and connects to a base station in a cellular communication system via a radio channel. The base station connects to the Internet with a wire. With this configuration, the mobile terminal apparatus functions as an access point for connecting the client to the Internet.

The client can connect to the Internet through higher speed communication via a broadband channel than via a cellular communication system. For this reason, it is expected that the client has a need for connection to the Internet via the broadband channel in an environment in which the broadband channel is available. As a technique of fulfilling this need, conventionally, a radio communication system is known in which a client switches the route for accessing to the Internet between the cellular communication system and the broadband channel (e.g. see PTL 1).

### CITATION LIST

### Patent Literature

### PTL 1

### Japanese Patent Application Laid-Open No. 2002-47096

### SUMMARY OF INVENTION

### Technical Problem

In PTL 1, however, a problem arises in which the client determines the destination of the route of connection to perform switching of the destination and thus the operation of switching destination of the route of connection at the client is troublesome.

It is an object of the present invention to provide a communication terminal apparatus and a communicating method that allow a client not to perform a troublesome operation of switching destination of the route of connection and improve the usability.

### Solution to Problem

A communication terminal apparatus according to the present invention includes: an AP operation section configured to connect to a communication party to perform short-range radio communication and to relay data transmission between the communication party and a connection destination of the communication party in place of an access point; an electric field intensity acquiring section configured to measure an electric field intensity of a signal received from the access point; and a client disconnecting section configured to determine whether the communication party is located in a communication area of the access point based on the electric field intensity measured by the electric field intensity acquiring section, and to disconnect the connection with the communication party in the AP operation section if having determined that the communication party is located in the communication area.

A communicating method in a communication terminal apparatus configured to operate as an access point according to the present invention, the method includes: connecting to a communication party to perform short-range radio communication and relaying data transmission between the communication party and a connection destination of the communication party in place of an access point; measuring an electric field intensity of a signal received from the access point; determining whether the communication party is located in a communication area of the access point based on the measured electric field intensity; and disconnecting the connection with the communication party if having determined that the communication party is located in the communication area.

### Advantageous Effects of Invention

According to the present invention, it is possible to allow a client not to perform a troublesome operation of switching destination of the route of connection and improve the usability.

### BRIEF DESCRIPTION OF DRAWINGS

FIG. 1 is a block diagram of a configuration of a communication terminal apparatus according to an embodiment of the present invention;

FIG. 2 is a flow chart showing an operation of a communication terminal apparatus according to an embodiment of the present invention;

FIG. 3 is a sequence diagram showing operations of a communication terminal apparatus, an access point, and a client in the case where the client succeeded in switching of connection from the communication terminal apparatus to the access point according to an embodiment of the present invention;

FIG. 4 is a sequence diagram showing operations of a communication terminal apparatus, an access point, and a client in the case where the client failed in switching of connection from the communication terminal apparatus to the access point according to an embodiment of the present invention;

FIG. 5 shows one example in which a client succeeds in switching of connection from a communication terminal apparatus to an access point according to an embodiment of the present invention;

FIG. 6 shows one example in which a client fails in switching of connection from a communication terminal apparatus to an access point according to an embodiment of the present invention; and

FIG. 7 shows a method of updating a threshold according to an embodiment of the present invention.

### DESCRIPTION OF EMBODIMENT

Hereinafter, an embodiment of the present invention will be described in detail with reference to the accompanying drawings.

### Embodiment

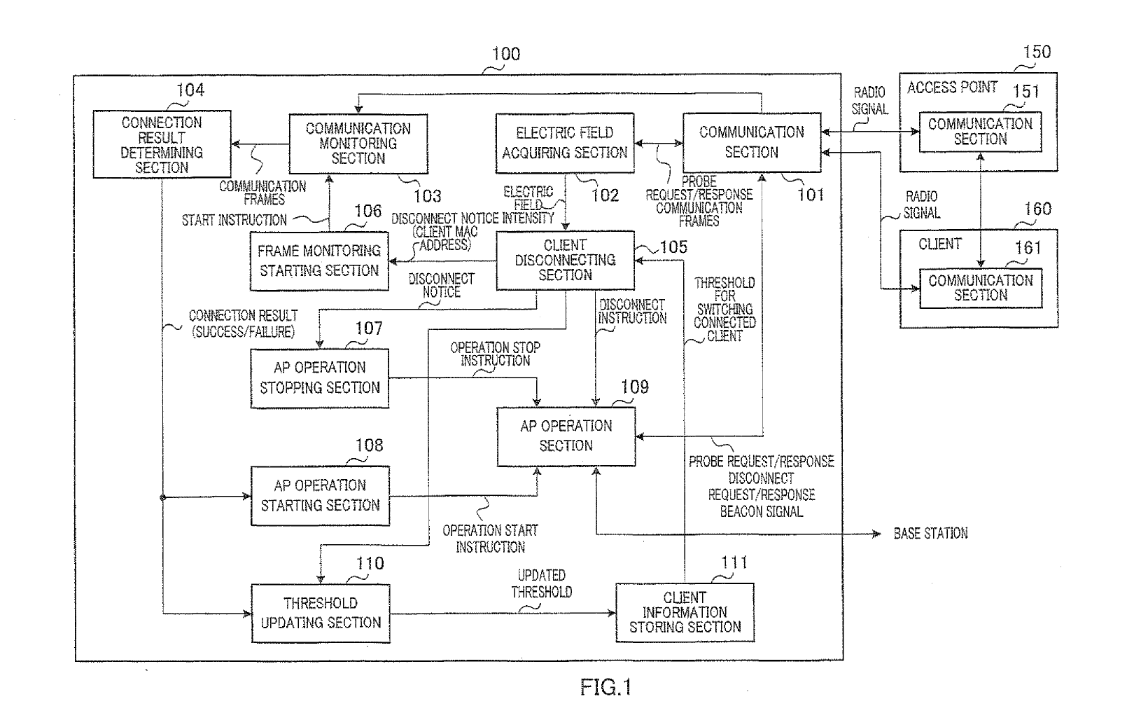

FIG. 1 is a block diagram of a configuration of communication terminal apparatus 100 according to an embodiment of the present invention.

Communication terminal apparatus 100 mainly includes communication section 101, electric field intensity acquiring section 102, communication monitoring section 103, connection result determining section 104, client disconnecting section 105, frame monitoring starting section 106, access point (AP) operation stopping section 107, AP operation starting section 108, AP operation section 109, threshold updating section 110, and client information storing section 111. Each component will be described in detail below.

Communication section 101 receives a signal transmitted through a radio channel from communication section 151 of access point 150 or communication section 161 of client 160 such as a portable gaming device, and outputs the received signal to electric field intensity acquiring section 102, communication monitoring section 103 or AP operation section 109. Communication section 101 transmits various signals or data received from communication monitoring section 103 or AP operation section 109 to communication section 151 of access point 150 or communication section 161 of client 160 through the radio channel. The radio channel connecting communication section 101 and client 160 is a short-range radio communication channel, such as a wireless LAN or Bluetooth.

Electric field intensity acquiring section 102 searches for (i.e., scans) access point 150. Specifically, electric field intensity acquiring section 102 generates a probe request signal in order to search for the access point, and outputs the generated. probe request signal to communication section 101. Upon receiving a response signal to the probe request signal from communication section 101, electric field intensity acquiring section 102 detects access point 150. Electric field intensity acquiring section 102 measures the electric field intensity of a reception signal of access point 150 that is received from communication section 101, and outputs the measurement result to client disconnecting section 105.

Communication monitoring section 103 monitors communication frames between access point 150 and client 160 in the reception signal received from communication section 101 within a predetermined monitoring time based on an instruction of frame monitoring starting section 106. Communication monitoring section 103 outputs the communication frames between access point 150 and client 160 to connection result determining section 104.

Connection result determining section 104 monitors connection sequences between access point 150 and client 160 by analyzing the communication frames transmitted and received between access point 150 and client 160, which are received from communication monitoring section 103. Connection result determining section 104 deter les the connection result between access point 150 and client 160 based on the monitored connection sequences. Connection result determining section 104 outputs the determination result to AP operation starting section 108 and threshold updating section 110. The connection result between access point 150 and client 160 means a success or failure in the connection between access point 150 and client 160.

Client disconnecting section 105 refers to client information stored in client information storing section 111 (described later) acid retrieves a threshold associated with the MAC address of currently-connected client 160 from client information storing section 111. Client disconnecting section 105 compares the retrieved threshold with the measurement result of the electric field intensity from electric field intensity acquiring section 102, and determines whether to disconnect the connection with client 160 based on the comparison result. Specifically, if the value of the measurement result of the electric field intensity is equal to the threshold or greater, client disconnecting section 105 determines that client 160, which should be located near to the communication terminal apparatus 100, is located in the communication area of access point 150 and disconnects the connection with client 160. If the value of the measurement result of the electric field intensity is less than the threshold, client disconnecting section 105 determines that client 160 is located outside the communication area of access point 150 and does not disconnect the connection with client 160. Furthermore, client disconnecting section. 105 retrieves the MAC address of currently-connected client 160, which is stored in client information storing section 111, from client information storing section 111. If having determined to disconnect the connection with client 160, client disconnecting section 105 instructs AP operation section 109 to disconnect the connection with client 160, and outputs the MAC address of client 160 as a disconnect notice to frame monitoring starting section 106. If having determined to disconnect the connection with client 160, client disconnecting section 105 outputs the disconnect notice to AP operation stopping section 107. Furthermore, if having determined to disconnect the connection with client 160, client disconnecting section 105 outputs to AP operation section 109 a disconnect instruction signal giving an instruction on disconnection of the connection with client 160. Client disconnecting section 105 outputs to threshold updating section 110 the measurement result of the electric field intensity acquired from electric field intensity acquiring section 102.

Upon acquiring a MAC address of client 160 from client disconnecting section 105, frame monitoring starting section 106 instructs communication monitoring section 103 to monitor communication frames between access point 150 and client 160 associated with the acquired MAC address.

Upon acquiring the disconnect notice from client disconnecting section 105, AP operation stopping section 107 outputs an operation stop instruction signal to AP operation section 109 to cause communication terminal apparatus 100 to stop the operation as an access point.

Upon acquiring the connection result indicating a failure in connection between access point 150 and client 160 from connection result determining section 104, AP operation starting section 108 outputs an operation start instruction signal to AP operation section 109 to cause communication terminal apparatus 100 to resume the terminal operation as an access point. On the other hand, upon acquiring the connection result indicating a success in the connection between access point 150 and client 160 from connection result determining section 104, AP operation starting section 108 does not perform any operation.

AP operation section 109 performs a function of operating as an access point for relaying data transmission between client 160 and the connection destination of client 160 such as the Internet, in place of access point 150. Specifically, AP operation section 109 transfers data contained in the reception signal from client 160, which is received from communication section 101, to the Internet via a base station (not shown) of a cellular communication system. Furthermore, AP operation section 109 outputs the data contained in the reception signal received from the Internet via the base station of the cellular communication system to communication section 101 for transfering to client 160. Explanation for a radio processing section, which performs a radio process of data transmitted and received between AP operation section 109 and the base station, and an antenna, which transmits and receives the data, will be omitted for easier explanation. Upon receiving the disconnect instruction signal from client disconnecting section 105 and upon receiving the operation stop instruction signal from AP operation stopping section 107, AP operation section 109 generates a disconnect request signal to request disconnection of the connection with client 160. AP operation section 109 outputs the generated disconnect request signal to communication section 101. Upon receiving the operation start instruction signal from AP operation starting section 108, AP operation section 109 starts the operation as an access point, generates a beacon signal that is used for identifying an access point, and outputs the generated beacon signal to communication section 101. AP operation section 109 does not operate as an access point during a predetermined monitoring time after receiving the disconnect instruction signal from client connection disconnecting section 105, even if receiving a response signal from communication section 101.

Threshold updating section 110, upon acquiring the connection result indicating a failure in connection between access point 150 and client 160 from connection result determining section 104, updates the threshold to a value equal to or greater than the value of the measurement result of the electric field intensity received from client disconnecting section 105. Threshold updating section 110 associates the MAC address of client 160 received from client disconnecting section 105 with the updated threshold, and causes client information storing section 111 to store the MAC address of client 160 and the threshold value associated with the MAC address.

Client information storing section 111 stores the threshold value associated with the MAC address of client 160, which is received from threshold updating section 110, as client information.

The configuration of communication terminal apparatus 100 has been described above.

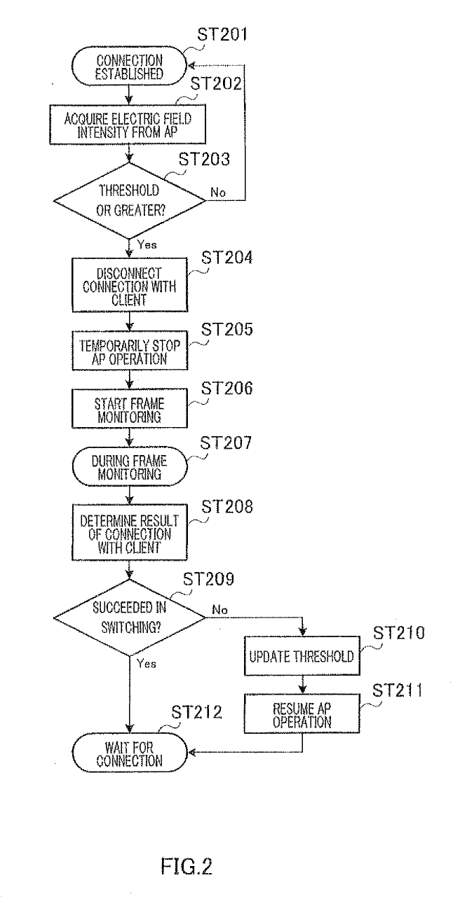

Next, the operation of communication terminal apparatus 100 will be described with reference to FIG. 2. FIG. 2 is a flow chart showing the operation of communication terminal apparatus 100.

First, when the connection between communication terminal apparatus 100 and client 160 is established (step ST201), communication terminal apparatus 100 operates as an access point. Electric field intensity acquiring section 102 acquires the measurement result of the electric field intensity of access point 150 (step ST202).

Next, client disconnecting section 105 determines whether the value of the measurement result of the electric field intensity is equal to the threshold or greater (step ST203).

If the value of the measurement result of the electric field intensity is less than the threshold (Step ST203: No), communication terminal apparatus 100 returns the process to step ST201.

If the value of the measurement result of the electric field intensity is equal to the threshold or greater (step ST203: Yes), client disconnecting section 105 disconnects the connection with client 160 (step ST204), and communication terminal apparatus 100 stops the operation as an access point.

AP operation section 109 generates and outputs the disconnect request signal, and temporarily stops the operation as an access point (step ST205).

Next, communication monitoring section 103 starts to monitor communication frames between access point 150 and client 160 (step ST206), and continues the monitoring for a predetermined monitoring time (step ST207).

Next, connection result determining section 104 determines the connection result between access point 150 and client 160 (step ST208).

Next, connection result determining section 104 determines whether client 160 succeeded in switching of connection from communication terminal apparatus 100 to access point 150 (step ST209).

If client 160 failed in switching connection from communication terminal apparatus 100 to access point 150 (step ST209: No), threshold updating section 110 updates the threshold (step ST210).

Next, AP operation section 109 generates and outputs a beacon signal and resumes the operation as an access point (step ST211).

Next, after client 160 ends the connection with the Internet, AP operation section 109 shifts to a stand-by operation for waiting the connection with client 160 (step ST212).

On the other hand, if client 160 succeeded in switching of connection from communication terminal apparatus 100 to access point 150 (step ST209: Yes), client 160 can connect to the Internet via access point 150. In that case, communication terminal apparatus 100 does not need to operate as an access point any more. Hence, AP operation section 109 shifts to the stand-by operation for waiting the connection with client 160 (step ST212).

The operation of communication terminal apparatus 100 has been described above.

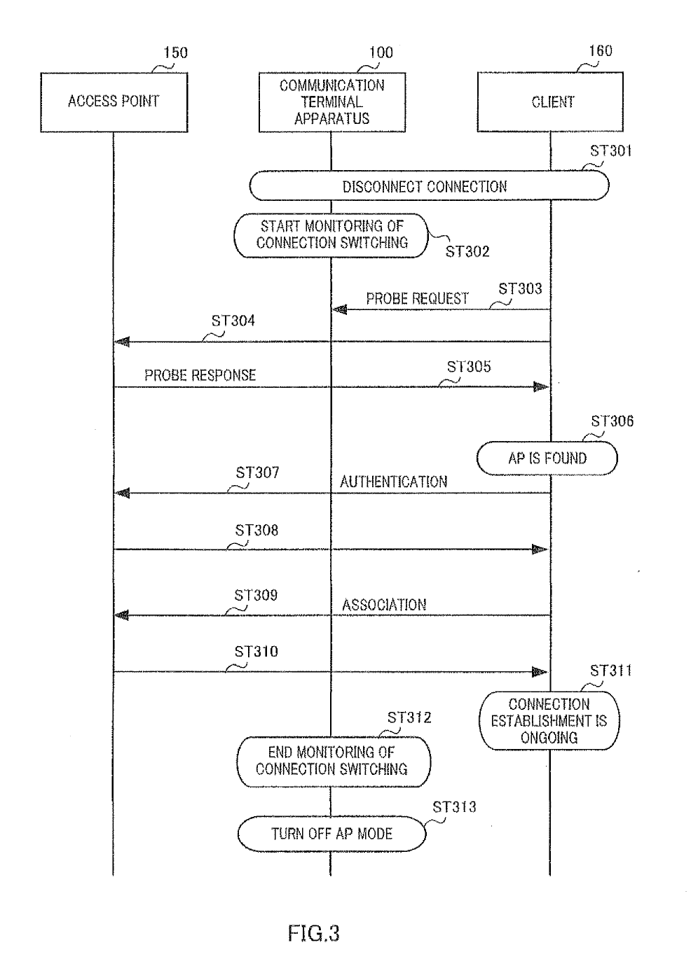

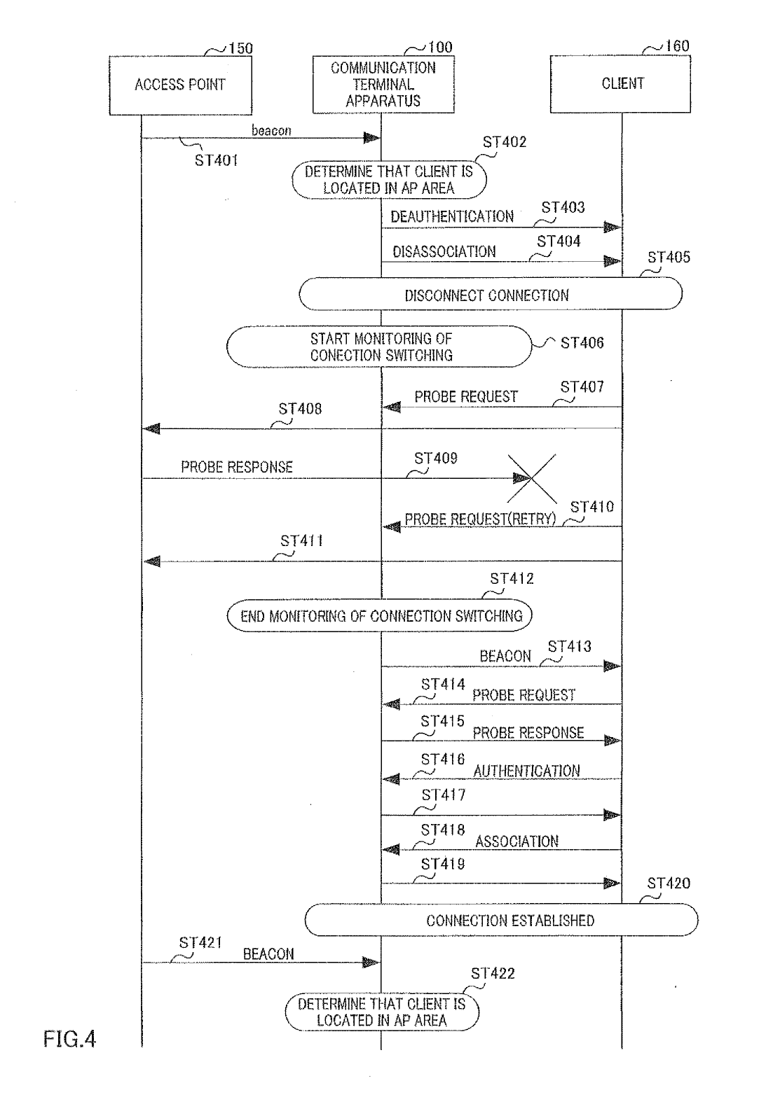

Next, operations of communication terminal apparatus 100, access point 150, and client 160 will be explained with reference to FIGS. 3 and 4. FIG. 3 is a sequence diagram showing operations of communication terminal apparatus 100, access point 150, and client 160 in the case where client 160 succeeded in switching of connection from communication terminal apparatus 100 to access point 150. FIG. 4 is a sequence diagram showing operations of communication terminal apparatus 100, access point 150, and client 160 in the case where client 160 failed in switching of connection from communication terminal apparatus 100 to access point 150.

First, operations of communication terminal apparatus 100, access point 150, and client 160 in the case where client 160 succeeded in switching of connection from communication terminal apparatus 100 to access point 150 will be explained with reference to FIG. 3.

AP operation section 109 of communication terminal apparatus 100 disconnects the connection with client 160 by generating and outputting a disconnect request signal (step ST301).

Next, communication monitoring section 103 of communication terminal apparatus 100 starts to monitor communication frames between access point 150 and client 160 and determines a predetermined monitoring time (step ST302). Communication monitoring section 103 monitors a search request (probe request), a search response (probe response), and a process for establishing synchronization (association) that are transmitted and received between access point 150 and client 160. The monitoring time refers to a predetermined time after communication terminal apparatus 100 disconnects the connection with client 160 (period from step ST302 to step ST312 in FIG. 3).

Next, client 160 transmits a probe request signal to communication terminal apparatus 100 (step ST303) and to access point 150 (step ST304), At this time, communication terminal apparatus 100 receives the probe request signal from client 160 in step ST303, but ignores the probe request signal because the reception occurs within the monitoring time.

Access point ISO receives the probe request signal and transmits a probe response signal as a response (step ST305).

Next, client 160 finds access point 150 by receiving the probe response signal (step ST306).

Next, client 160 performs an authentication process (authentication) with access point 150 (steps ST307 and ST308), and also performs a process for establishing synchronization (i.e., association) with access point 150 (steps ST309 and ST310).

Next, client 160 establishes the connection with access point 150 (step ST311).

Next, communication monitoring section 103 of communication terminal apparatus 100 ends monitoring the communication frames (step ST312).

Next, since the connection between access point 150 and client 160 has succeeded, AP operation section 109 of communication terminal apparatus 100 stops the operation and turns off the access point mode (step ST313).

Next, operations of communication terminal apparatus 100, access point 150, and client 160 in the case where client 160 failed in switching of connection from communication terminal apparatus 100 to access point 150 will be explained with reference to FIG. 4.

First, communication section 101 of communication terminal apparatus 100 receives a beacon used for identifying access point 150, from access point 150 (step ST401).

Next, client disconnecting section 105 of communication terminal apparatus 100 determines that client 160 is located in the communication area of access point 150 based on the measurement result of the electric field intensity of the reception signal from access point 150 (step ST402).

Next, AP operation section 109 of communication terminal apparatus 100 generates and outputs the disconnect request (deauthentication, disassociation) signal to allow communication terminal apparatus 100 to transmit the disconnect request signal to client 160 (steps ST403 and ST404).

Next, communication terminal apparatus 100 disconnects the connection with client 160 (step ST405). With this process, communication terminal apparatus 100 can automatically disconnect the connection with client 160.

Communication monitoring section 103 of communication terminal apparatus 100 starts to monitor the communication frames between access point 150 and client 160, and determines a predetermined monitoring time (step ST406).

Next, client 160 transmits a probe request signal to communication terminal apparatus 100 (step ST407) and to access point 150 (step ST408). At this time, communication terminal apparatus 100 receives the probe request signal from client 160 in step ST407, but ignores the probe request signal because the reception occurs within the monitoring time (period from step ST406 to step ST412 in FIG. 4).

Access point 150 receives the probe request signal and transmits a probe response signal as a response (step ST409). Client 160, however, fails in reception of the probe response signal.

Since having failed in reception of the probe response signal, client 160 retransmits the probe request signal to communication terminal apparatus 100 (step ST410) and to access point 150 (step ST411). At this time, communication terminal apparatus 100 receives the probe request signal from client 160 in step ST410, but ignores the probe request signal as with the case of step ST407, because the reception occurs within the monitoring time.

Communication monitoring section 103 of communication terminal apparatus 100 ends monitoring the communication frames (step ST412).

Next, AP operation section 109 of communication terminal apparatus 100 transmits a beacon to client 160 (step ST413).

Next, since having failed in the connection with access point 150, client 160 transmits a probe request signal to communication terminal apparatus 100 (step ST414).

Next, AP operation section 109 of communication terminal apparatus 100 transmits a probe response signal to client 160 (step ST415).

Next, communication terminal apparatus 100 executes an authentication process with client 160 (steps ST416 and ST417), and executes an association process with client 160 (step ST418 and step ST419).

Next, communication terminal apparatus 100 establishes the connection with client 160 (step ST420).

Next, access point 150 transmits a beacon (step ST421).

Next, client disconnecting section. 105 of communication terminal apparatus 100 determines that client 160 is located in the communication area of access point 150 based on the measurement result of the electric field intensity of the reception signal from access point 150 (step ST422). At this time, although client disconnecting section 105 of communication terminal apparatus 100 determined that client 160 was located in the communication area of access point 150 in step ST402, in reality, client 160 has failed to connect with access point 150. Hence, threshold updating section 110 of communication terminal apparatus 100 sets, as the threshold value, a value equal to or greater than the value of the measurement result of the electric field intensity, which is measured in the determination in step ST402. This allows client disconnecting section 105 to compare a value of the measurement result of the electric field intensity with a greater threshold in the determination in step ST422 than in step ST402.

The operations of communication terminal apparatus 100, access point 150, and client 160 have been described above.

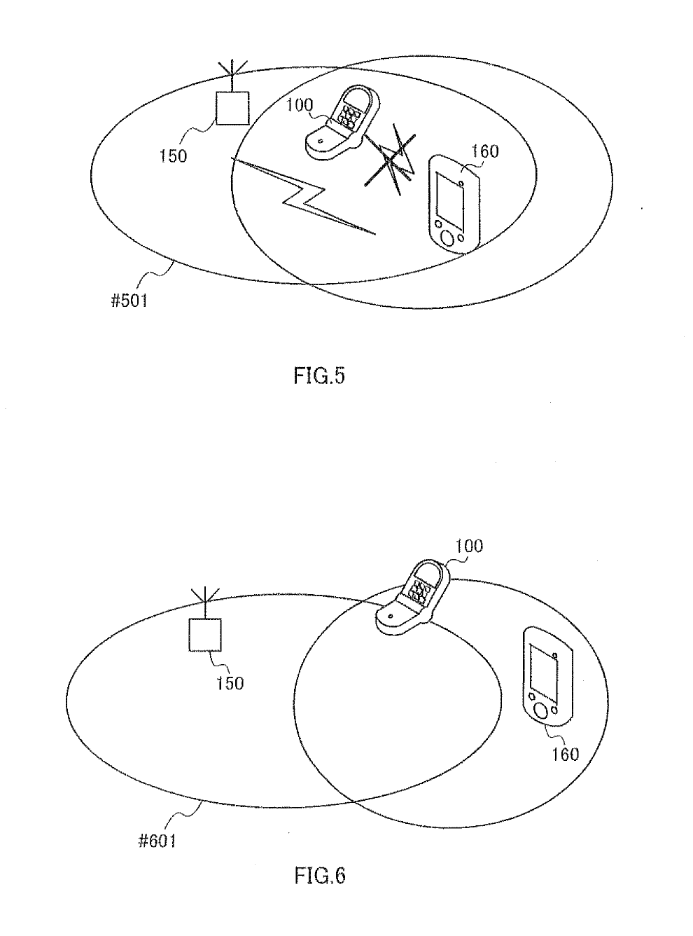

FIG. 5 shows one example in which client 160 succeeds in switching of connection from communication terminal apparatus 100 to access point 150.

FIG. 5 shows that both communication terminal apparatus 100 and client 160 are located in communication area #501 of access point 150. In this case, because the value of the measurement result of the electric field intensity, which is detected by communication terminal apparatus 100, is equal to or greater than the threshold, client disconnecting section 105 of communication terminal apparatus 100 can determine that client 160 is located in communication area #501 of access point 150. Hence, AP operation section 109 of communication terminal. apparatus 100 stops the operation as an access point and client 160 succeeds in connecting with access point 150.

In this way, in the case where communication terminal apparatus 100, access point 150, and client 160 have the positional relationship as shown in FIG. 5, client 160 succeeds in connecting with access point 150 as shown in FIG. 3.

FIG. 6 shows one example in which client 160 fails in switching of connection from communication terminal apparatus 100 to access point 150.

FIG. 6 shows that communication terminal apparatus 100 is located in communication area #601 of access point 150 whereas client 160 is not located in communication area #601 of access point 150. In this case, because the value of the measurement result of the electric field intensity, which is detected by communication terminal apparatus 100, is equal to or greater than the threshold, client disconnecting section 105 of communication terminal apparatus 100 determines that client 160 is located in communication area #601 of access point 150. In reality, however, client 160 is located outside the communication area #601 of access point 150. Thus, client 160 fails in connection with access point 150.

In this way, in the case where communication terminal apparatus 100, access point 150, and client 160 have the positional relationship as shown in FIG. 6, client 160 fails in connection with access point 150 as shown in FIG. 4.

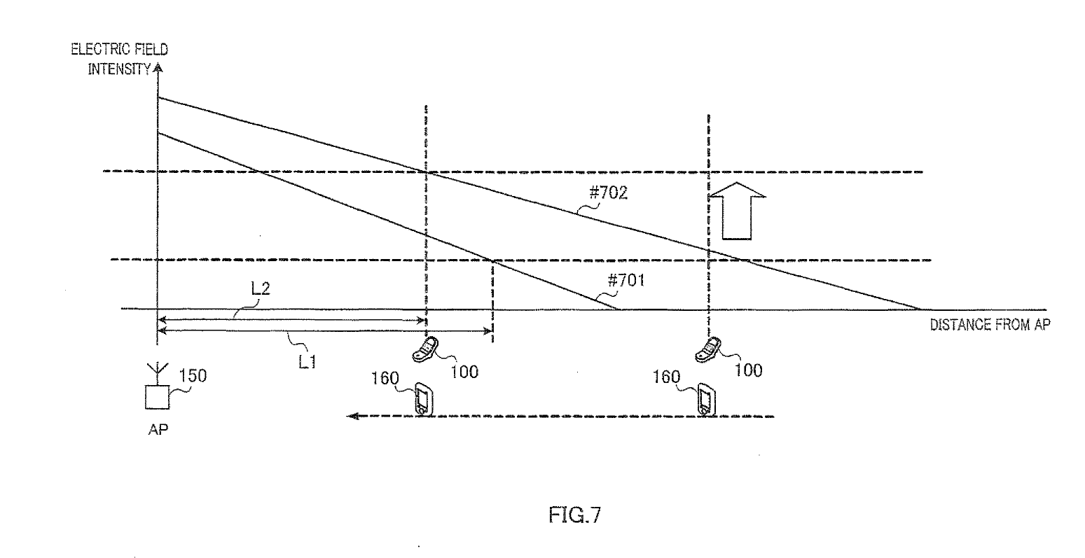

Next, the method of updating the threshold will be explained with reference to FIG. 7. FIG. 7 shows the method of updating the threshold.

In FIG. 7, at first, the threshold is set as threshold #701. If client 160 fails in connection with access point 150, then threshold updating section 110 sets threshold #702 that indicates a value of the electric field intensity greater than threshold #701.

With this configuration, for example, in the case where threshold #701 is used for determination about the communication area of the access point, communication terminal apparatus 100 determines that client 160 is located in the communication area of access point 150 if the distance between communication terminal apparatus 100 and access point 150 is within distance L1. On the other hand, in the case where the updated threshold #702 is used for the determination about the communication area of the access point, communication terminal apparatus 100 determines that client 160 is located in the communication area of access point 150 if the distance between communication terminal apparatus 100 and access point 150 is within distance L2 (L1>L2). Hence, in the case where the updated threshold #702 is used for the determination, compared to the case where threshold #701 is used, communication terminal apparatus 100 needs to be located closer to access point 150 to determine that client 160 is located in the communication area of access point 150.

In this way, according to the present embodiment, upon determining that the client is located in the communication area of the access point, the communication terminal apparatus automatically disconnects the connection with the client. This allows the client not to perform a troublesome switching operation between the communication terminal apparatus and the access point and improve the usability. Furthermore, according to the present embodiment, the communication terminal apparatus does not respond to a probe request transmitted from the client within a predetermined monitoring time. For this reason, the client is prevented from being connected to the communication terminal apparatus in the case where the client is located in the communication area of the access point. Furthermore, according to the present embodiment, in the ease where the client fails in connection with the access point, the client tries to connect to the communication terminal apparatus. This can prevent the case where the client cannot connect to the Internet for the reason that the client cannot connect to either of the access point or the communication terminal apparatus. Furthermore, according to the present embodiment, in the case where the client fails in connection with the access point, the threshold used for comparison with the electric field intensity received from the access point by the communication terminal apparatus is updated to a value equal to or greater than the value of the electric field intensity from the access point. This can improve the accuracy of determining whether the client is located in the communication area of the access point next time.

Although the threshold is updated in the present embodiment, the present invention is not limited to this. The threshold does not have to be updated. Furthermore, although the electric field intensity is used to determine whether a client is located in the communication area of an access point in the present embodiment, the present invention is not limited to this. Alternatively, any parameters other than the electric field intensity, which can be used to estimate the distance between a client and an access point, may be used.

Furthermore, according to the present embodiment, the operation of the client disconnecting section is not limited to the above, and various changes may be applied to the operation in the range of the present invention.

For example, the client disconnecting section may decrease the communication rate, may generate a communication error, or may decrease radio output power in the case where the electric field intensity is equal to the e threshold or greater. With this configuration, in the case where a client supports handover, the communication terminal apparatus allows the client to switch the connection destination without temporary disconnection with the client.

Furthermore, according to the present embodiment, the client disconnecting section may disconnect the connection with a client in the case where the client does not disconnect the connection even if the communication rate is decreased, the error is generated, or the radio output power is decreased, as described above. This allows a client supporting handover to perform handover and allows a client not supporting handover to switch the connection destination.

According to the present embodiment, the client disconnecting section may stop the operation as an access point without performing the connection disconnection sequences.

According to the present embodiment, the client disconnecting section may inform a user that the connection destination can be switched, by a user interface (UI) display, sound, vibration or light, instead of automatic disconnection of the connection. With this configuration, a user does not need to confirm whether there is a connection destination, and the user can determine whether to switch the connection destination.

According to the present embodiment, the client disconnecting section may suspend switching of the connection destination in the case where the client is performing communication even if the condition for switching the connection destination is met. With this configuration, the ongoing communication can be prevented from being terminated and the communication terminal apparatus can allow the client to switch the connection destination while the client is not performing communication.

According to the present embodiment, the client disconnecting section may determine whether the section switches the connection destination based on the communication status (presence or absence of other clients, or the traffic load) of an access point being the target connection destination. With this configuration, the client disconnecting section can prevent the connection destination from being switched if the target connection destination is an access point which may be unsuitable for stable and high-speed communication.

Furthermore, according to the present embodiment, the operation of the frame monitoring starting section is not limited to the above, and various changes may be applied to the operation in the range of the present invention.

For example, according to the present embodiment, the frame monitoring starting section may always monitor the radio signals. This makes the configuration of the present invention simpler.

Furthermore, according to the present embodiment, if the client is expected to fail in the connection with an access point, the frame monitoring starting section may disguise itself as an access point by operating as an access point having the same extended service set identifier (ESSID) as the expected access point, in order to relay the communication of the client to a cellular communication system. With this configuration, the client can perform communication again even when not trying to reconnect to the access point or even when not performing a periodic probe operation.

According to the present embodiment, if the client is expected to fail in the connection with an access point, the frame monitoring starting section may connect to the access point in the wireless distribution system (WDS) mode to relay the communication of the client to the access point. With this configuration, the client can perform communication again even when riot trying to reconnect to the access point or even when not performing a periodic probe operation. Furthermore, because the client performs communication via the access point, the client can perform higher-speed communication compared to the case of the communication by relay via a cellular communication system.

According to the present embodiment, the frame monitoring starting section may cause the communication terminal apparatus to resume the operation as an access point when the client starts a process of connecting to an access point. This increases the chance in which other clients connect to the access point. In that case, the communication terminal apparatus has already resumed the operation as an access point even if the client fails in connection with the terminal. Thus, even in the case where it requires long time for the communication terminal apparatus to resume the operation as an access point, the client can connect to the access point immediately.

According to the present embodiment, the frame monitoring starting section can automatically cause the communication terminal apparatus to start the operation as an access point, upon detecting the movement of the client from the inside to the outside of the communication area of the access paint while the communication terminal apparatus is not performing the operation as an access point. With this configuration, the communication terminal apparatus automatically starts the operation as an access point if the client is located outside the communication area of the access point, omitting the user operation of starting the operation as an access point operation.

Furthermore, according to the present embodiment, the operation of the AP operation stopping section is not limited to the above, and various changes may be applied to the operation in the range of the present invention.

For example, according to the present embodiment, the AP operation stopping section is allowed not to transmit a response to a particular client that has switched the connection destination. With this configuration, if a plurality of clients are connecting to the communication terminal apparatus, clients other than the particular client can continue the communication.

According to the present embodiment, the AP operation stopping section may transmit a reject response to a connection request from a particular client. With this configuration, if a plurality of clients are connecting to the communication terminal apparatus, clients other than the particular client can continue the communication.

According to the present embodiment, if the client succeeded in switching of the connection destination from the communication terminal apparatus to an access point, the AP operation stopping section may stop the operation as an access point by determining that the access point function is not needed because the client is already located in the communication area of the access point. This can reduce waste power consumption.

Furthermore, according to the present embodiment, the operation of the threshold updating section is not limited to the above, and various changes may be applied to the operation in the range of the present invention.

For example, according to the present embodiment, in the case where the terminal could not confirm a probe request or a connection request from a client after the client failed in switching of the connection from the communication terminal apparatus to an access point, the threshold updating section may register the client as a client not to be processed through automatic switching. With this configuration, in the case where the client does not perform a reconnection operation or a periodic probe operation, the communication terminal apparatus cannot perform automatic switching, but can identify the client not subject to automatic switching. This can prevent unnecessary termination of the connection.

According to the present embodiment, in the case where the terminal could not confirm a probe request or a connection request from a client after the client failed in switching of the connection from the communication terminal apparatus to an access point, the threshold updating section may update the threshold to a greater value than expected normally. With this configuration, because the greater threshold value does not meet the condition for automatic switching, it is possible to obtain the same effect as the case of registering the client as a client not subject to automatic switching.

The disclosure of Japanese Patent Application No. 2010-139866, filed on Jun. 18, 2010, including the specification, drawings and abstract, is incorporated herein by reference in its entirety.

### INDUSTRIAL APPLICABILITY

The communication terminal apparatus and. communicating method according to the present invention are suitable especially for an operation as an access point.

### Reference Signs List

100 communication terminal apparatus
101, 151, 161 communication section
102 electric field intensity acquiring section
103 communication monitoring section
104 connection result determining section
105 client disconnecting section
106 frame monitoring starting section
107 AP operation stopping section
108 AP operation starting section
109 AP operation section
110 threshold updating section
111 client information storing section
150 access point
160 client

1-5. (canceled)

6. A communication terminal apparatus comprising:
an access point (AP) operation section configured to connect to a communication party to perform short-range radio communication and to relay data transmission between the communication party and a connection destination of the communication party in place of an access point;
an electric field intensity acquiring section configured to measure an electric field intensity of a signal received from the access point;
a client disconnecting section configured to determines whether the communication party is located in a communication area of the access point based on the electric field intensity measured by the electric field intensity acquiring section, and to disconnect the connection with the communication party in the AP operation section if having determined that the communication party is located in the communication area;
a communication monitoring section configured to monitor an communication status between the communication party and the access point; and
an access point (AP) operation controlling section configured to control an operation of the AP operation section based on the communication status.

7. The communication terminal apparatus according to claim 6, wherein the AP operation controlling section is further configured to stop the operation of the AP operation section within a predetermined monitoring period after the disconnection.

8. The communication terminal apparatus according to claim 7, wherein the AP operation controlling section is further configured to start the operation of the AP operation section if the communication party fails to connect to the access point during the monitoring period.

9. The communication terminal apparatus according to claim 6, wherein the client disconnecting section is configured to determine that the communication party is located in the communication area of the access point if the electric field intensity measured by the electric field intensity acquiring section is equal to or greater than a threshold, and to update the threshold to a value equal to or greater than the electric field intensity measured by the electric field intensity acquiring section if the communication party fails to connect to the access point after the disconnection.

10. A communicating method in a communication terminal apparatus configured to operate as an access point, the method comprising:
a relay step of connecting to a communication party to perform short-range radio communication and relaying data transmission between the communication party and a connection destination of the communication party in place of an access point;
a measuring step of measuring an electric field intensity of a signal received from the access point;
a determining step of determining whether the communication party is located in a communication area of the access point based on the measured electric field intensity;
a disconnecting step of disconnecting the connection with the communication party if the determining step determines that the communication party is located in the communication area;
a monitoring step of monitoring a communication status between the communication party and the access point; and
a controlling step of controlling an operation of the relay step based on the communication status.
